(19) United States
(12) Patent Application Publication
(10) Pub. No.: US 2026/0187781 A1
(43) Pub. Date: Jul. 2, 2026

(54) MALFUNCTION DETERMINATION METHOD

(71) Applicant: TOYOTA JIDOSHA KABUSHIKI KAISHA, Toyota-shi (JP)

(72) Inventor: Kei MASUDA, Mishima-shi (JP)

(73) Assignee: TOYOTA JIDOSHA KABUSHIKI KAISHA, Toyota-shi (JP)

(21) Appl. No.: 19/392,457

(22) Filed: Nov. 18, 2025

(30) Foreign Application Priority Data
Dec. 11, 2024 (JP) 2024-217083

(51) Int. Cl. G06T 7/00; B60Q 11/00

(52) U.S. Cl. CPC G06T 7/0008; B60Q 11/005; G06T 2207/30252

(57) ABSTRACT

A malfunction determination method includes transmitting an inspection start instruction from a first vehicle to be inspected, to second vehicles to be used for an inspection of the first vehicle, performing, by the first vehicle, inspection operations based on a predetermined pattern, recording, by the second vehicles, operations of the first vehicle, and performing malfunction determination for the first vehicle, based on the recorded operations.

### CROSS-REFERENCE TO RELATED APPLICATION

This application claims priority to Japanese Patent Application No. 2024-217083 filed on Dec. 11, 2024, the entire contents of which are incorporated herein by reference.

### TECHNICAL FIELD

The present disclosure relates to a malfunction determination method.

### BACKGROUND

Technology related to malfunction detection in vehicles is known. For example, Patent Literature (PTL) 1 discloses technology for determining, using wireless communication, whether a rear lamp of a target vehicle is lit.

### CITATION LIST

### Patent Literature

PTL 1: JP 2015-212133 A

### SUMMARY

There is room for improvement with respect to technology related to malfunction detection in vehicles.

It would be helpful to improve technology related to malfunction detection in vehicles.

A malfunction determination method according to an embodiment of the present disclosure includes:
transmitting an inspection start instruction from a first vehicle to be inspected, to a second vehicle to be used for an inspection of the first vehicle;
performing, by the first vehicle, an inspection operation based on a predetermined pattern;
recording, by the second vehicle, an operation of the first vehicle; and
performing malfunction determination for the first vehicle, based on the recorded operation.

According to an embodiment of the present disclosure, technology related to malfunction detection in vehicles is improved.

### BRIEF DESCRIPTION OF THE DRAWINGS

In the accompanying drawings:

FIG. 1 is a schematic diagram illustrating a schematic configuration of a vehicle according to an embodiment of the present disclosure; and

FIG. 2 is a sequence diagram illustrating operations of a malfunction determination system.

### DETAILED DESCRIPTION

Hereinafter, an embodiment of the present disclosure will be described.

### Outline of Embodiment

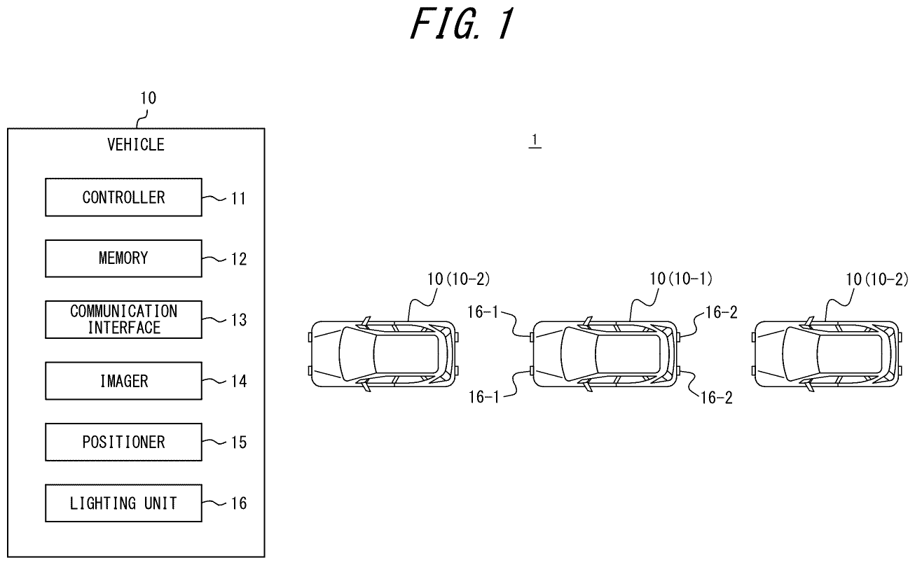

An outline of the malfunction determination system 1 according to the embodiment of the present disclosure will be described. As shown in FIG. 1, the malfunction determination system 1 includes multiple vehicles 10. The multiple vehicles 10 may be configured to communicate with each other directly or via a network. The leftmost vehicle 10 is shown with its components in a block diagram. The other three vehicles 10 are not shown in a block diagram but have a similar configuration.

In this embodiment, the vehicle 10 is, for example, an automobile, but is not limited to this and may be any vehicle. The automobile is, for example, a battery electric vehicle (BEV), a hybrid electric vehicle (HEV), a plug-in hybrid electric vehicle (PHEV), a fuel cell electric vehicle (FCEV), or the like, but is not limited to these. The number of vehicles 10 included in the malfunction determination system 1 may be freely determined.

First, an outline of this embodiment will be described, and details thereof will be described later. The first vehicle 10-1 to be inspected sends an inspection start instruction to the second vehicle 10-2 used for inspecting the first vehicle 10-1. Subsequently, the first vehicle 10-1 performs inspection operations based on a predetermined pattern, and the second vehicle 10-2 records the operations of the first vehicle 10-1. The first vehicle 10-1 determines whether it is malfunctioning based on the data recorded by the second vehicle 10-2.

Thus, according to this embodiment, the inspection operations of the first vehicle 10-1 are recorded by multiple second vehicles 10-2. Therefore, the first vehicle 10-1 can be inspected simultaneously from multiple directions. This allows for a reduction in the personnel required for inspection and a shortening of the time needed for inspection. Additionally, since the inspector does not need to exit the inspection vehicle, safety during inspection is improved. Furthermore, the second vehicle 10-2 records inspection operations based on a predetermined pattern. Thus, when a malfunction occurs, the malfunction location can be identified by comparing the predetermined pattern with the actual operations. Therefore, the safety of vehicle inspections is improved, and efficiency is enhanced, thereby improving the technology related to malfunction determination of vehicles.

Next, the configurations of the malfunction determination system 1 will be described in detail. The malfunction determination system 1 includes multiple vehicles 10.

As illustrated in FIG. 1, the vehicle 10 includes a controller 11, a memory 12, a communication interface 13, an imager 14, a positioner 15, and a lighting unit 16.

The controller 11 includes at least one processor, at least one programmable circuit, at least one dedicated circuit, or a combination of these. The processor is, for example, a general purpose processor such as a central processing unit (CPU) or a graphics processing unit (GPU), or a dedicated processor that is dedicated to specific processing, but is not limited to these. The programmable circuit is a field-programmable gate array (FPGA), for example, but is not limited to this. The dedicated circuit is an application specific integrated circuit (ASIC), for example, but is not limited to this. The controller 11 executes various processes related to the operations of the vehicle 10 and controls the components of the vehicle 10.

The memory 12 includes one or more memories. The memories are, for example, semiconductor memories, magnetic memories, optical memories, or the like, but are not limited to these. The memories included in the memory 12 may each function as, for example, a main memory, an auxiliary memory, or a cache memory. The memory 12 stores any information to be used for the operations of the vehicle 10. For example, the memory 12 may store a system program, an application program, embedded software, and the like.

The communication interface 13 includes one or more communication interfaces. The communication interface is compliant with, for example, mobile communication standards for connecting to a network, wired local area network (LAN) standards, or wireless LAN standards, but is not limited to these and may be compliant with any communication standard. In the present embodiment, the vehicle 10 communicates with other vehicles 10 via the communication interface 13 and the network. The vehicle 10 may communicate directly with other vehicles 10 without going through the network.

The imager 14 includes at least one camera that can capture images of subjects. The camera is a forward camera, a side camera, a rear camera, or the like. The imager 14 may include distance measuring devices such as millimeter-wave radar or LiDAR. The camera may produce one or more still images or one or more moving images.

The positioner 15 includes one or more apparatuses that acquire positional information on the vehicle 10. Specifically, the positioner 15 includes a receiver corresponding to the Global Positioning System (GPS), for example, but is not limited to this and may include a receiver corresponding to any satellite positioning system.

The lighting unit 16 is a lamp necessary for the operation of the vehicle 10. The lighting unit 16 includes headlamps, tail lamps, brake lamps, and turn signal lamps. The lighting unit 16 may include, for example, light-emitting diodes (LEDs), organic electro-luminescent (EL) devices, incandescent bulbs, and the like. The operation of the lighting unit 16 may be controlled by the controller 11.

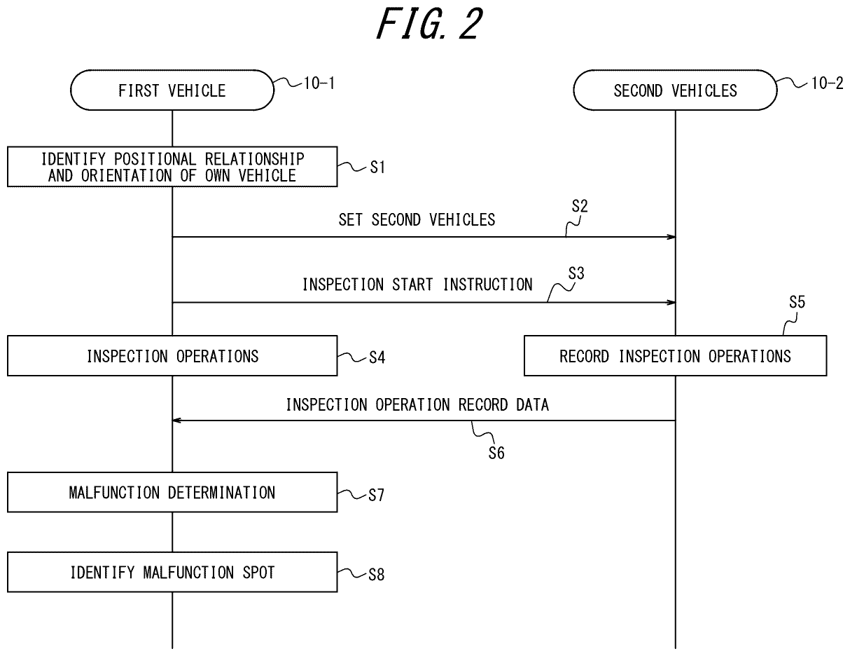

With reference to FIG. 1 and FIG. 2, the operations of the malfunction determination system 1 according to the present embodiment will be described. As illustrated in FIG. 1, in the present embodiment, multiple vehicles 10 are arranged in a line. Among the multiple vehicles 10, the vehicle 10 to be inspected is the first vehicle 10-1. The second vehicle 10-2, which records the operations of the first vehicle 10-1, is arranged in front of and behind the first vehicle 10-1. The multiple vehicles 10 may be parked in the above arrangement before inspection. FIG. 2 is a sequence diagram showing the operations of the malfunction determination system 1 in the present embodiment.

S1: The vehicle 10-1 identifies the positional relationship and orientation of its own vehicle. The identification of the positional relationship and orientation of the own vehicle by vehicle 10 can adopt any method. For example, the positioner 15 may identify the positional relationship and orientation of the own vehicle based on the position information obtained from GPS. Vehicle 10 may obtain LiDAR sensing information with the imaging unit 14 in addition to or instead of position information to identify the positional relationship and orientation of the own vehicle.

S2: The vehicle 10-1 identifies the preceding and following vehicles 10 and sets the vehicle 10 as the second vehicle 10-2.

The method for identifying the preceding and following vehicles 10 can be any method. For example, the first vehicle 10-1 may obtain position information and/or LiDAR sensing information acquired by the other vehicle 10. The first vehicle 10-1 may identify the preceding and following vehicles 10 by comparing the position information and/or LiDAR sensing information of its own vehicle and the other vehicle 10, and set it as the second vehicle 10-2.

As another example of the method for identifying the preceding and following vehicles 10, the first vehicle 10-1 may instruct the other vehicle 10 to capture the vehicles 10 located in front of and behind each respective vehicle 10. The other vehicle 10 captures photos or videos with the imaging unit 14 and sends them to the first vehicle 10-1. The controller 11 of the first vehicle 10-1 analyzes the received photos or videos and extracts the photos or videos in which the own vehicle is captured. The controller 11 of the first vehicle 10-1 identifies the preceding and following vehicles 10 as the vehicle 10 that is the source of the extracted photos or videos and sets it as the second vehicle 10-2.

The other vehicle 10 may capture any photos or videos as long as the preceding and following vehicles 10 are visible. For example, the other vehicle 10 may capture photos or videos showing the license plates of the preceding and following vehicles 10. In this case, the controller 11 of the first vehicle 10-1 may identify the vehicle 10 that captured the license plate matching its own vehicle's number as the preceding and following vehicles 10 and set it as the second vehicle 10-2.

Additionally, the first vehicle 10-1 may perform a specific action, and the other vehicle 10 may capture photos or videos that include the part where the specific action is performed among the preceding and following vehicles 10. For example, the first vehicle 10-1 may turn on a specific light unit 16. The other vehicle 10 may capture photos or videos of the specific light unit 16. The controller 11 of the first vehicle 10-1 may identify the preceding and following vehicles 10 as the vehicle 10 that captured the specific light unit 16 that is lit and set it as the second vehicle 10-2.

The first vehicle 10-1 may determine whether the setting of the second vehicle 10-2 is correct by combining multiple methods for identifying the preceding and following vehicles 10.

S3: The controller 11 of the first vehicle 10-1 sends an inspection start instruction to the second vehicle 10-2 via the communication interface 13.

S4: The controller 11 of the first vehicle 10-1 causes each part of the first vehicle 10-1 to perform inspection operations based on a predetermined pattern. The predetermined pattern may be, for example, the order in which the lighting unit 16 of the vehicle 10 is turned on. In this case, the predetermined pattern may have different orders set for the front lighting unit 16-1 and the rear lighting unit 16-2 of the vehicle 10. The inspection operations may be any operations. For example, it may be an operation to turn on the lighting unit 16 of the first vehicle 10-1 based on a predetermined pattern. The predetermined pattern may be stored in the memory 12 of the first vehicle 10-1.

S5: When the second vehicle 10-2 receives the inspection start instruction, it starts recording the inspection operations performed by the first vehicle 10-1. The method of recording by the second vehicle 10-2 may be any method. For example, it may be a method of capturing the first vehicle 10-1 with the imaging unit 14 of the second vehicle 10-2.

S6: When the inspection operation of the first vehicle 10-1 is completed, the controller 11 of the second vehicle 10-2 sends the recorded data to the first vehicle 10-1 via the communication interface 13.

S7: The controller 11 of the first vehicle 10-1 compares the recorded data received from the second vehicle 10-2 with the predetermined pattern and determines whether there is a failure at the location where the inspection operation was performed. If there is a failure, the process proceeds to S8. If there is no failure, the process ends.

If the recorded data is a photo or video, the controller 11 of the first vehicle 10-1 may perform image analysis on the recorded data, detect the inspection operation of the first vehicle 10-1, and compare it with the predetermined pattern. Image processing may be performed using, for example, YOLO (You Only Look Once) or CNN (Convolutional Neural Network).

S8: The controller 11 of the first vehicle 10-1 compares the recorded data with the predetermined pattern to identify the location of the failure. The method of comparison processing may be the same as in S7. The process then ends.

As described above, the first vehicle subject to inspection according to the present embodiment sends an inspection start instruction to the second vehicle used for the inspection of the first vehicle. Subsequently, the first vehicle performs inspection operations based on a predetermined pattern, and the second vehicle records the operations of the first vehicle. Based on the data recorded by the second vehicle, determine whether the first vehicle is malfunctioning.

According to such a configuration, the inspection operations of the first vehicle are recorded by multiple second vehicles. Therefore, the first vehicle 10-1 can be inspected simultaneously from multiple directions. This allows for a reduction in the personnel required for inspection and a shortening of the time needed for inspection. Additionally, since the inspector does not need to exit the inspection vehicle, safety during inspection is improved. Furthermore, the second vehicle 10-2 records inspection operations based on a predetermined pattern. Thus, when a malfunction occurs, the malfunction location can be identified by comparing the predetermined pattern with the actual operations. Therefore, the safety of vehicle inspections is improved, and efficiency is enhanced, thereby improving the technology related to malfunction determination of vehicles.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or divided.

For example, in the embodiment described above, it is also possible to aggregate part of the configuration and operation of the vehicle into the information processing apparatus. For example, the information processing apparatus may include some or all components of the control unit and memory of the vehicle.

In addition, in the embodiment described above, the travel route and/or parking location of multiple vehicles may be set in advance. The first vehicle can determine its positional relationship and orientation by communicating with other vehicles or the information processing apparatus to acquire that it is positioned at the set travel route and/or parking location. As a result, it is possible to identify the positional relationship and orientation of the vehicle without adding special sensors.

In addition, in the embodiment described above, multiple vehicles may accept input of positional relationship and orientation from external sources.

1. A malfunction determination method comprising:
transmitting an inspection start instruction from a first vehicle to be inspected, to a second vehicle to be used for an inspection of the first vehicle;
performing, by the first vehicle, an inspection operation based on a predetermined pattern;
receiving, by the second vehicle, the inspection start instruction, imaging the inspection operation of the first vehicle, and transmitting, to the first vehicle, an image captured; and
detecting, by the first vehicle, an operation of the first vehicle from the image received from the second vehicle, and determining presence or absence of a malfunction in the first vehicle by comparing the detected operation with the predetermined pattern.

2. A malfunction determination method comprising:
transmitting an inspection start instruction from a first vehicle to be inspected, to a second vehicle to be used for an inspection of the first vehicle;
performing, by the first vehicle, an inspection operation based on a predetermined pattern;
recording, by the second vehicle, an operation of the first vehicle; and
performing malfunction determination for the first vehicle, based on the recorded operation.

3. The malfunction determination method according to claim 2, wherein the malfunction determination includes determining presence or absence of a malfunction and identifying a malfunction spot, by comparing the recorded operation with the predetermined pattern.

4. The malfunction determination method according to claim 2, wherein
the recording of the operation of the first vehicle includes:
imaging, by the second vehicle, the inspection operation of the first vehicle; and
transmitting, by the second vehicle to the first vehicle, an image captured, and
the malfunction determination includes performing, by the first vehicle, image analysis on the image.

5. The malfunction determination method according to claim 2, wherein
the predetermined pattern includes order of lighting a lighting unit of the first vehicle, and
the inspection operation includes lighting the lighting unit based on the predetermined pattern.

6. The malfunction determination method according to claim 2, further comprising:
before the first vehicle transmits the inspection start instruction, arranging multiple second vehicles in front of and behind the first vehicle; and
recording, by the respective multiple second vehicles, a front and rear of the first vehicle,
wherein
the predetermined pattern includes order of lighting a front lighting unit and a rear lighting unit of the first vehicle, and
the inspection operation includes lighting the front lighting unit and the rear lighting unit based on the predetermined pattern.
